(19) United States
(12) Patent Application Publication
(10) Pub. No.: US 2026/0286972 A1
(43) Pub. Date: Sep. 24, 2026

(54) ROTOR ASSEMBLY WITH INTERCHANGEABLE BLADES

(71) Applicant: Rescue South, Inc., Canton, NC (US)

(72) Inventor: Jeremy Edmonds, Canton, NC (US)

(73) Assignee: Rescue South, Inc., Canton, NC (US)

(21) Appl. No.: 19/577,288

(22) Filed: Mar. 24, 2026

Related U.S. Application Data
(60) Provisional application No. 63/776,909, filed on Mar. 24, 2025.

(51) Int. Cl. F04D 29/32; F04D 3/00; F04D 29/34; F04D 29/38

(52) U.S. Cl. CPC F04D 29/329; F04D 3/005; F04D 29/34; F04D 29/388; F05D 2260/31; F05D 2300/2102; F05D 2300/433; F05D 2300/603

(57) ABSTRACT

A rotor assembly for use with a pump jet, axial-flow pump, jet drive, or similar fluid propulsion system includes a central hub defining a sleeve passage extending axially therethrough, an adapter sleeve received within the sleeve passage and defining a shaft passage configured to receive a drive shaft, and a plurality of removable and replaceable blades extending radially outward from the central hub. Each blade is individually removably secured to the central hub by mechanical fasteners at blade-mounting stations, enabling field-serviceable removal and replacement of individual blades without disassembly of the central hub or adapter sleeve. The blades are interchangeable with blades of different pitch, profile, and diameter configurations to adapt the rotor assembly for different operating conditions. The adapter sleeve is interchangeable to accommodate drive shafts of different manufacturers. The modular construction reduces weight, manufacturing cost, and field-repair downtime relative to conventional monolithic rotor assemblies.

### CROSS-REFERENCE TO RELATED APPLICATIONS

This application claims the benefit of U.S. Provisional Application No. 63/776,909, filed Mar. 24, 2025, the entire disclosure of which is hereby incorporated by reference.

### FIELD OF THE INVENTION

The present invention relates generally to rotor assemblies for fluid-moving apparatus and, more particularly, to a modular rotor assembly comprising a central hub and a plurality of individually removable and replaceable blades configured for use with pump jets, axial-flow pumps, jet drives, and similar fluid propulsion systems.

### BACKGROUND OF THE INVENTION

Axial-flow pumps and pump jets are widely employed across a range of marine, rescue, and industrial applications for generating thrust or moving fluid along an axial direction. Such systems typically include a rotor assembly disposed within a housing and driven by a drive shaft coupled to a prime mover, such as an outboard engine or an electric motor. The rotor assembly functions to accelerate fluid axially through the housing, thereby producing thrust or pumping action.

Conventional rotor assemblies for axial-flow pumps are formed as a single, monolithic component in which the rotor hub, blades, and adapter sleeve are integrally cast or machined as one piece. While monolithic rotor assemblies have generally performed adequately for their intended purpose, such designs present significant limitations in terms of serviceability, adaptability, and lifecycle cost.

For example, if one or more blades of a conventional monolithic rotor assembly become damaged during operation—such as through impact with debris, cavitation erosion, or fatigue cracking—the entire rotor assembly must be removed from the pump jet or axial-flow pump and either returned to the manufacturer for repair or replaced as a complete unit. This requirement imposes substantial downtime, cost, and logistical burden on end users, particularly in mission-critical applications such as flood-water rescue, emergency response, and infrastructure protection, where the rapid return of equipment to operational status can be a matter of life safety.

Additionally, conventional monolithic rotor assemblies are inherently limited to a single blade geometry—that is, a fixed pitch, profile, and diameter—determined at the time of manufacture. Because different operating environments, watercraft platforms, and prime movers may require different blade characteristics to achieve optimal performance, end users who operate across multiple platforms or in varying environmental conditions must maintain an inventory of multiple complete rotor assemblies, each having a different fixed blade geometry. This requirement further increases cost and logistical complexity.

Moreover, because different equipment manufacturers employ different drive shaft configurations, conventional monolithic rotor assemblies must be manufactured in application-specific variants to accommodate these differences. This proliferation of variants increases manufacturing complexity and inventory requirements for both manufacturers and end users.

Accordingly, there is a need in the art for a rotor assembly that addresses the foregoing limitations by providing individually removable and replaceable blades that can be serviced in the field by end users with minimal tools and skills, that accommodates blades of variable pitch, profile, and diameter to optimize performance across different operating conditions and applications, and that is adaptable for use with equipment manufactured by different manufacturers through the use of interchangeable adapter sleeves.

### SUMMARY

In accordance with one aspect of the present invention, there is provided a rotor assembly for use with an axial-flow pump, pump jet, jet drive, or similar fluid propulsion system. The rotor assembly comprises a central hub defining a sleeve passage extending axially therethrough, an adapter sleeve received within the sleeve passage and defining a shaft passage configured to receive a drive shaft, and a plurality of removable and replaceable blades extending radially outward from the central hub. Each blade of the plurality of blades is individually removably secured to the central hub by at least one mechanical fastener, such that any individual blade may be removed from and replaced on the central hub independently of the remaining blades without disassembly of the central hub or the adapter sleeve.

In accordance with another aspect of the present invention, the removable and replaceable blades are configured as universal blades installable on central hubs of different configurations, thereby enabling a single blade design to be used across multiple applications and with equipment produced by different manufacturers.

In accordance with yet another aspect of the present invention, the plurality of removable and replaceable blades may be provided in different blade configurations having varying profiles, pitches, and diameters, such that the performance characteristics of the rotor assembly may be selectively altered by substituting blades of one configuration for blades of another configuration.

The modular construction of the rotor assembly advantageously enables field-serviceable repair and replacement of individual damaged blades using a single hand tool, adaptation of the rotor assembly to different operating conditions by blade substitution, compatibility with multiple equipment manufacturers through interchangeable adapter sleeves, and reduced weight and manufacturing cost relative to conventional monolithic rotor assemblies.

### BRIEF DESCRIPTION OF THE DRAWING

For a more complete understanding of the present invention and the advantages thereof, reference is now made to the following description taken in conjunction with the accompanying drawings, in which:

FIG. 1 is a perspective view of a rotor assembly having a first central hub configuration, shown installed within a pump jet housing;

FIG. 2 is a front perspective view of a rotor assembly having a second central hub configuration different from the first central hub configuration of FIG. 1, illustrating the central hub, adapter sleeve, mechanical fasteners, and plurality of removable blades;

FIG. 3 is a rear perspective view of the rotor assembly of FIG. 2, illustrating the rear face of the central hub, the adapter sleeve, and the shaft passage;

FIG. 4 is a perspective view of a single removable blade in accordance with an embodiment of the present invention, illustrating the blade base with fastener apertures and locating feature; and

FIG. 5 is a side elevational view of the removable blade of FIG. 4, illustrating the blade profile and pitch.

### DETAILED DESCRIPTION

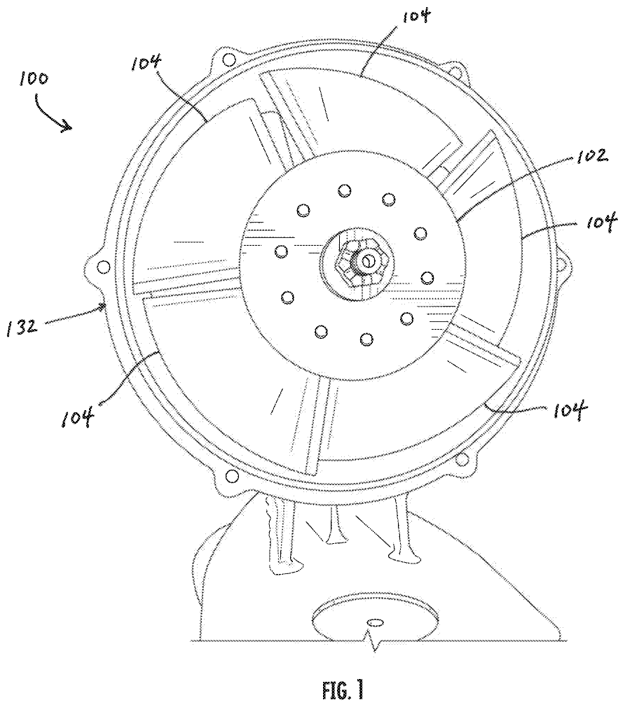

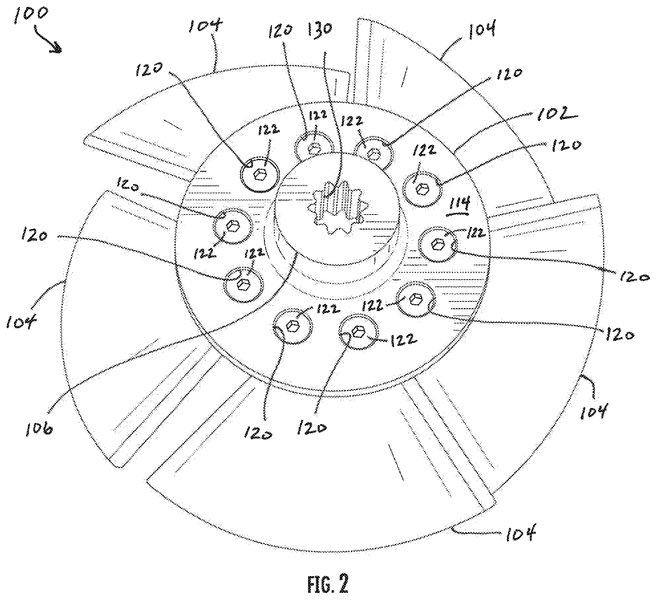

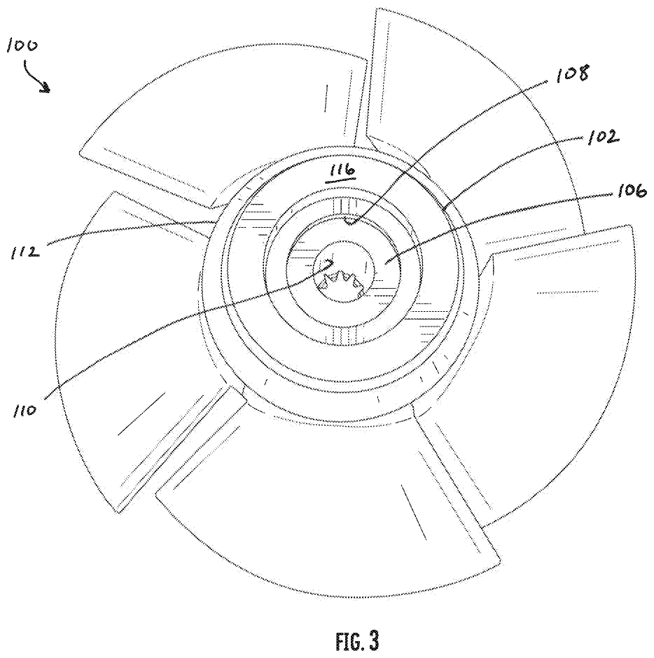

Referring now to the drawings, wherein like reference numerals designate like elements throughout the several views, there is shown in FIGS. 1-5 a rotor assembly 100 in accordance with embodiments of the present invention. The rotor assembly 100 is configured for use with an axial-flow pump, pump jet, jet drive, or similar fluid propulsion system, and comprises a central hub 102, a plurality of removable and replaceable blades 104 extending radially outward from the central hub 102, and an adapter sleeve 106 accommodated within the central hub 102. As will be described in greater detail below, FIG. 1 illustrates the rotor assembly 100 having a first central hub configuration installed within a pump jet housing, and FIGS. 2 and 3 illustrate the rotor assembly 100 having a second, different central hub configuration, thereby demonstrating the adaptability of the rotor assembly 100 across different equipment platforms.

Referring particularly to FIGS. 1-3, the central hub 102 is a generally disk-shaped or cylindrical body having a front face 114 (FIG. 2) and an opposing rear face 116 (FIG. 3). The central hub 102 defines a sleeve passage 108 extending axially through the central hub 102 from the front face 114 to the rear face 116. The sleeve passage 108 is configured to receive the adapter sleeve 106 therein. In the illustrated embodiment, the central hub 102 is machined from a billet of aluminum alloy, which provides favorable strength-to-weight characteristics and corrosion resistance suitable for marine environments. However, the central hub 102 may alternatively be constructed from other suitable materials, including, without limitation, stainless steel, bronze, titanium alloys, glass-reinforced nylon, or other fiber-reinforced polymeric materials, depending on the requirements of the particular application.

The central hub 102 further includes a plurality of blade-mounting stations disposed about the outer peripheral surface 112 of the central hub 102 and arranged in a circumferentially spaced pattern. In the illustrated embodiment, the central hub 102 includes five blade-mounting stations, although it will be understood that greater or fewer blade-mounting stations may be provided depending on the desired number of blades 104. Each blade-mounting station includes at least one threaded hole 120 formed in the front face 114 of the central hub 102 and extending into the hub body. As best seen in FIG. 2, the threaded holes 120 are positioned to receive mechanical fasteners 122 therethrough for securing the blades 104 to the central hub 102. In the illustrated embodiment, each blade-mounting station includes two threaded holes 120 arranged in a radial pattern, and the front face 114 of the central hub 102 further includes a countersink recess associated with each threaded hole 120 to accommodate the head of the mechanical fastener 122 in a flush or near-flush relationship with the front face 114.

The adapter sleeve 106 is received coaxially within the sleeve passage 108 of the central hub 102 and defines a shaft passage 110 extending axially therethrough. The shaft passage 110 is configured to receive and couple with a drive shaft of a prime mover. As seen in FIG. 2, in one embodiment, the shaft passage 110 includes a splined bore 130 having a plurality of internal splines configured to engage corresponding external splines on a drive shaft, thereby providing a positive rotational drive coupling between the drive shaft and the rotor assembly 100. As shown in FIG. 3, the rear face 116 of the central hub 102 provides access to the shaft passage 110, and the peripheral edge of the adapter sleeve 106 is visible from the rear of the assembly where the adapter sleeve 106 is received within the sleeve passage 108.

The adapter sleeve 106 may be formed integrally with the central hub 102 as a unitary machined component, or the adapter sleeve 106 may be a separate component insertable into the sleeve passage 108. In embodiments where the adapter sleeve 106 is separate from the central hub 102, the adapter sleeve 106 may be press-fit, interference-fit, adhesively bonded, or mechanically retained within the sleeve passage 108. This modular adapter sleeve configuration advantageously permits a single central hub 102 to be adapted for use with drive shafts of different sizes and configurations—such as those produced by different outboard engine manufacturers—simply by substituting one adapter sleeve 106 for another having a differently configured shaft passage 110. In a further alternative embodiment, a commercially available rubber hub may be used in place of the adapter sleeve 106 to provide shock absorption and torque-limiting functionality.

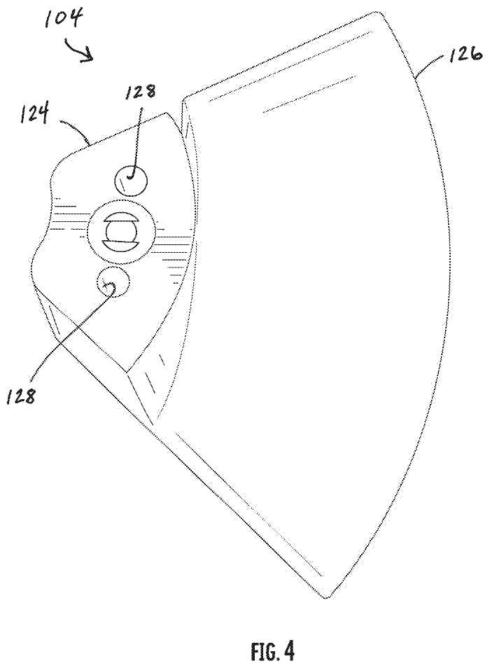

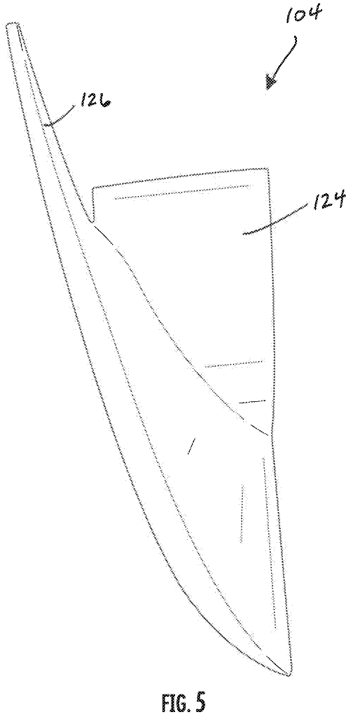

Referring now particularly to FIGS. 4 and 5, each removable blade 104 of the plurality of blades 104 includes a blade base 124 and a blade body 126 extending radially outward from the blade base 124. The blade base 124 is the proximal mounting portion of the blade 104 that interfaces with the central hub 102, and the blade body 126 is the distal working portion of the blade 104 that engages the fluid during operation.

As best seen in FIG. 4, the blade base 124 includes at least one fastener aperture 128 formed in the blade base 124. In the illustrated embodiment, each blade base 124 includes two fastener apertures 128 arranged in a pattern corresponding to the threaded holes 120 on the central hub 102, such that when the blade base 124 is positioned against the front face 114 of the central hub 102 at a blade-mounting station, the fastener apertures 128 are registrable with the corresponding threaded holes 120. A mechanical fastener 122, such as a socket head cap screw, hex bolt, or other suitable fastener, is engaged with each fastener aperture 128 and the corresponding threaded hole 120 to removably secure the blade 104 to the central hub 102. The blade base 124 may further include a locating feature, such as a boss, key, or tongue, configured to engage a corresponding locating feature on the central hub 102, such as a recess, keyway, or groove, to positively locate the blade 104 in a predetermined angular orientation relative to the central hub 102 and to resist rotational shear loads during operation.

The blade body 126 has an airfoil or hydrofoil cross-sectional profile configured to efficiently move fluid in the axial direction when the rotor assembly 100 is rotated about its central axis. As shown in FIG. 5, each blade body 126 is formed with a predetermined pitch, which is the helical angle of the blade surface relative to the plane of rotation. The blade body 126 extends from the blade base 124 to a radially outermost tip, defining a blade diameter. The blade body 126 is contoured with a leading edge and a trailing edge, with a pressure surface on one side and a suction surface on the opposing side, to generate axial fluid flow and thrust when rotated.

In the illustrated embodiment, the blades 104 are constructed from glass-reinforced nylon, which provides a favorable combination of strength, stiffness, weight, and chemical resistance for marine applications. However, the blades 104 may alternatively be constructed from other suitable materials, including, without limitation, carbon-fiber-reinforced nylon, other fiber-reinforced polymeric composites, aluminum alloys, stainless steel, bronze, or combinations thereof, depending on the requirements of the particular application.

A key feature of the rotor assembly 100 is the interchangeability of the blades 104. Because the blades 104 are individually removably secured to the central hub 102 by mechanical fasteners 122, each blade 104 can be independently removed from and replaced on the central hub 102 without disturbing the remaining blades 104 and without requiring disassembly of the central hub 102 or the adapter sleeve 106. The removal and replacement of a blade 104 may be accomplished using a single hand tool, such as an Allen wrench or socket wrench, corresponding to the head type of the mechanical fasteners 122. This field-serviceability is particularly advantageous in mission-critical applications, such as flood-water rescue, emergency response, and infrastructure protection, where the rapid return of equipment to operational status is essential.

The interchangeability of the blades 104 further enables the rotor assembly 100 to be configured with blades 104 of different blade configurations having varying profiles, pitches, and diameters. For example, a first set of blades 104 having a first pitch and diameter may be installed on the central hub 102 for use in a first operating environment or with a first type of prime mover, and the first set of blades 104 may subsequently be removed and replaced with a second set of blades 104 having a second, different pitch and/or diameter for use in a second operating environment or with a second type of prime mover. The blade base 124 geometry and fastener aperture 128 pattern may be standardized across different blade configurations, such that blades of different pitch, profile, and diameter may all be mounted on the same central hub 102 at the same blade-mounting stations.

In accordance with a further aspect of the present invention, the blades 104 are configured as universal blades, meaning that the blade base 124 geometry and fastener aperture 128 pattern are configured to be compatible with central hubs 102 of different configurations and sizes. This universal blade design enables end users to maintain a single inventory of blades 104 that can be used across multiple rotor assemblies 100 configured for different equipment manufacturers and applications, thereby reducing inventory requirements and associated costs.

In operation, the rotor assembly 100 is assembled by selecting the appropriate adapter sleeve 106 for the target drive shaft and installing the adapter sleeve 106 in the sleeve passage 108 of the central hub 102 (if the adapter sleeve 106 is a separate component). The desired blades 104 are then secured to the central hub 102 at the blade-mounting stations using the mechanical fasteners 122. The assembled rotor assembly 100 is then installed within the housing of the pump jet, axial-flow pump, or jet drive, and the shaft passage 110 of the adapter sleeve 106 is coupled to the drive shaft. During operation, rotation of the drive shaft causes the rotor assembly 100 to rotate, and the blades 104 move fluid axially through the housing to generate thrust or pumping action.

Referring to FIG. 1, a rotor assembly 100 having a first central hub configuration is shown installed within a pump jet housing 132. The central hub 102 is positioned centrally within the pump jet housing 132, and the plurality of blades 104 extend radially outward from the central hub 102 toward the inner wall of the pump jet housing 132. A retaining nut or shaft coupling is visible at the center of the front face 114, securing the rotor assembly 100 to a drive shaft (not shown). In the illustrated configuration, five blades 104 are provided, equally spaced circumferentially about the central hub 102, although any suitable number of blades may be employed as noted above.

Referring to FIGS. 2 and 3, a rotor assembly 100 having a second central hub configuration is shown, illustrating that the central hub 102 may be manufactured in different configurations to accommodate drive shafts of different sizes, spline patterns, or coupling arrangements, such as those employed by different equipment manufacturers. The first central hub configuration shown in FIG. 1 and the second central hub configuration shown in FIGS. 2 and 3 each receive the same plurality of removable and replaceable blades 104, demonstrating that the blades 104 are universal and interchangeable across different central hub configurations. The central hubs 102 of the first and second configurations may differ in overall diameter, sleeve passage 108 geometry, shaft passage 110 spline configuration, fastener type, or other dimensional attributes, while maintaining a common blade-mounting station geometry that permits the same blades 104 to be installed on either configuration.

Testing of prototype rotor assemblies 100 in accordance with the present invention has demonstrated a weight reduction of approximately twenty-six percent (26%) relative to conventional monolithic rotor assemblies of comparable performance. Additionally, the modular construction of the rotor assembly 100 is projected to reduce manufacturing costs relative to monolithic designs by reducing both material costs and machining labor, because the central hub 102 and the blades 104 may be manufactured separately using processes optimized for each component—for example, CNC machining for the central hub 102 and injection molding for the blades 104.

Although the rotor assembly 100 has been illustrated and described in the context of pump jets and axial-flow pumps, it will be understood that the principles of the present invention are applicable to other fluid-moving apparatus and propulsion systems, including, without limitation, jet drives for watercraft, industrial pumps, ventilation fans, and other rotary fluid-moving equipment. Furthermore, while the illustrated embodiment shows a five-blade configuration, the rotor assembly 100 may be configured with any suitable number of blades, including, without limitation, three, four, five, six, seven, or more blades, depending on the requirements of the particular application.

While the foregoing description has set forth preferred and alternative embodiments of the present invention in particular detail, it is to be understood that the above description is illustrative only and is not to be construed as limiting the scope of the invention. The scope of the present invention is defined by the appended claims, and all changes that come within the meaning and range of equivalents of the claims are intended to be embraced therein.

What is claimed is:

1. A rotor assembly for use with a fluid propulsion system, the rotor assembly comprising:
a central hub defining a sleeve passage extending axially therethrough, the central hub having a front face, a rear face opposing the front face, and an outer peripheral surface, the central hub further including a plurality of blade-mounting stations disposed about the outer peripheral surface, each blade-mounting station including at least one threaded hole formed in the central hub;
an adapter sleeve received within the sleeve passage, the adapter sleeve defining a shaft passage configured to receive a drive shaft; and
a plurality of removable and replaceable blades, each blade comprising a blade base and a blade body extending radially outward from the blade base, the blade base including at least one fastener aperture registrable with a corresponding threaded hole of a respective blade-mounting station, each blade being individually removably secured to the central hub at a respective blade-mounting station by at least one mechanical fastener cooperatively engaging the at least one fastener aperture and the at least one threaded hole;
wherein each blade of the plurality of blades is independently removable from and replaceable on the central hub without removal of the remaining blades and without disassembly of the adapter sleeve from the central hub.

2. The rotor assembly of claim 1 wherein each blade of the plurality of blades is formed from a fiber-reinforced polymeric material.

3. The rotor assembly of claim 2 wherein the fiber-reinforced polymeric material comprises glass-reinforced nylon.

4. The rotor assembly of claim 1 wherein the adapter sleeve is formed integrally with the central hub as a unitary machined component.

5. The rotor assembly of claim 1 wherein the adapter sleeve is a separate component received within the sleeve passage of the central hub, such that the adapter sleeve is interchangeable with a differently configured adapter sleeve to accommodate drive shafts of different configurations.

6. The rotor assembly of claim 1 wherein the shaft passage of the adapter sleeve includes a splined bore having a plurality of internal splines configured to engage corresponding external splines on the drive shaft.

7. The rotor assembly of claim 1 wherein each blade-mounting station includes two threaded holes arranged in a radial pattern, and each blade base includes two fastener apertures arranged in a corresponding pattern, such that each blade is secured to the central hub by two mechanical fasteners.

8. The rotor assembly of claim 1 wherein the plurality of removable and replaceable blades are interchangeable with blades of at least one different blade configuration having at least one of a different pitch, a different profile, or a different diameter, the blade base geometry and fastener aperture pattern being standardized across different blade configurations.

9. A modular rotor assembly system for an axial-flow pump, the system comprising:
a central hub defining a sleeve passage extending axially therethrough, the central hub including a plurality of circumferentially spaced blade-mounting stations, each blade-mounting station including at least one threaded receiving feature;
a first adapter sleeve receivable within the sleeve passage, the first adapter sleeve defining a first shaft passage having a first drive-coupling configuration;
a second adapter sleeve receivable within the sleeve passage, the second adapter sleeve defining a second shaft passage having a second drive-coupling configuration different from the first drive-coupling configuration;
a first set of removable blades, each blade of the first set having a first blade configuration including a first pitch and a first diameter, each blade of the first set including a blade base having at least one fastener aperture alignable with the at least one threaded receiving feature of a respective blade-mounting station; and
a second set of removable blades, each blade of the second set having a second blade configuration including at least one of a second pitch different from the first pitch or a second diameter different from the first diameter, each blade of the second set including a blade base having at least one fastener aperture alignable with the at least one threaded receiving feature of a respective blade-mounting station;
wherein the first adapter sleeve and the second adapter sleeve are selectively interchangeable within the sleeve passage to adapt the central hub for use with drive shafts of different configurations, and wherein the first set of removable blades and the second set of removable blades are selectively interchangeable on the central hub to alter the performance characteristics of the rotor assembly.

10. The modular rotor assembly system of claim 9 wherein the at least one fastener aperture of each blade base of the first set of removable blades and the at least one fastener aperture of each blade base of the second set of removable blades have a common fastener aperture pattern, such that the first set of removable blades and the second set of removable blades are mountable on the central hub at the same blade-mounting stations.

11. The modular rotor assembly system of claim 9 wherein each blade of the first set and each blade of the second set is independently removable from and replaceable on the central hub by operation of a single hand tool.

12. The modular rotor assembly system of claim 9 wherein the central hub is constructed from a metallic material and the first set and the second set of removable blades are constructed from a fiber-reinforced polymeric material.

13. The modular rotor assembly system of claim 9 wherein the first drive-coupling configuration of the first adapter sleeve comprises a first splined bore configured to engage a first drive shaft, and the second drive-coupling configuration of the second adapter sleeve comprises a second splined bore configured to engage a second drive shaft of a different manufacturer.
